(19) United States
(12) Patent Application Publication
(10) Pub. No.: US 2023/0027689 A1
(43) Pub. Date: Jan. 26, 2023

(54) PET LEASH

(71) Applicants: Brett Robert Kincaid, Ada, MI (US); Marianne Wanda Menger, Ada, MI (US)

(72) Inventors: Brett Robert Kincaid, Ada, MI (US); Marianne Wanda Menger, Ada, MI (US)

(21) Appl. No.: 17/382,668

(22) Filed: Jul. 22, 2021

(51) Int. Cl. A01K 27/00

(52) U.S. Cl. CPC A01K 27/003

(57) ABSTRACT

A leash includes a strap of flexible material forming a loop and a body including at least two passageways extending through the body. The strap extends through each of the passageways, and the loop of the strap is formed by a continuous length of the strap that extends between the passageways. The strap slides through the passageways as desired to increase or decrease the size of the loop.

### BACKGROUND OF THE INVENTION

### 1. Field of the Invention

The present invention pertains to a leash. More particularly, the present invention pertains to a leash for a pet having a strap and a gripping element to hold the strap.

### 2. Description of the Prior Art

A leash is typically used with a pet to avoid any sudden movement like running or jumping of the pet, or to otherwise control where the pet walks or runs. Generally, pet owners use a leash secured to the neck or back of the pet to constrain the unwanted movement of the pet. However, the leash can be difficult to tie or loop around the hand or any other stationary object and therefore, the leash can slip from the hands of the pet owner. This is particularly true when the owner is wearing thick gloves, like in winter. This causes the leash to slip from the hands of the pet owner, which is undesirable.

### SUMMARY OF THE INVENTION

According to an aspect of the disclosure a leash is disclosed. The leash includes a strap of flexible material forming a loop, and a body including at least two passageways extending through the body. The strap extends through each of the passageways, and the loop of the strap is formed by a continuous length of the strap that extends between the passageways.

According to an embodiment, the leash comprises a strap of flexible material forming a loop; and a body including at least two passageways extending through the body; wherein the strap extends through each of the passageways, and the loop of the strap is formed by a continuous length of the strap that extends between the passageways.

Optionally, the body is spherical.

Optionally, the body is ovoidal.

Optionally, the ovoidal body consists of two axes of symmetry.

Optionally, the ovoidal body consists of one axis of symmetry.

Optionally, the body has at least one pair of openings, and each of the passageways extends between a respective pair of the openings.

Optionally, at least one of the openings is a slit.

Optionally, the slit is curved.

Optionally, both of the openings in the pair of openings are a slit.

Optionally, both of the openings in the pair of openings are a curved slit.

Optionally, the body consists of two passageways extending through the body.

Optionally, the body has two pairs of openings, and each of the passageways extends between a respective pair of the openings.

Optionally, the passageways are symmetrical with one another about an axis extending along the body.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 illustrates a leash having a strap and a body with the leash in a folded position, in accordance with an embodiment of the disclosure;

FIG. 2 illustrates the leash with the body dividing the strap into two loop portions, in accordance with an embodiment of the disclosure;

FIG. 3 illustrates a perspective view of the body, in accordance with an embodiment of the disclosure; and

FIG. 4 illustrates a sectional view of the body of FIG. 3, in accordance with an embodiment of the disclosure.

### DETAILED DESCRIPTION OF A PREFERRED EMBODIMENT

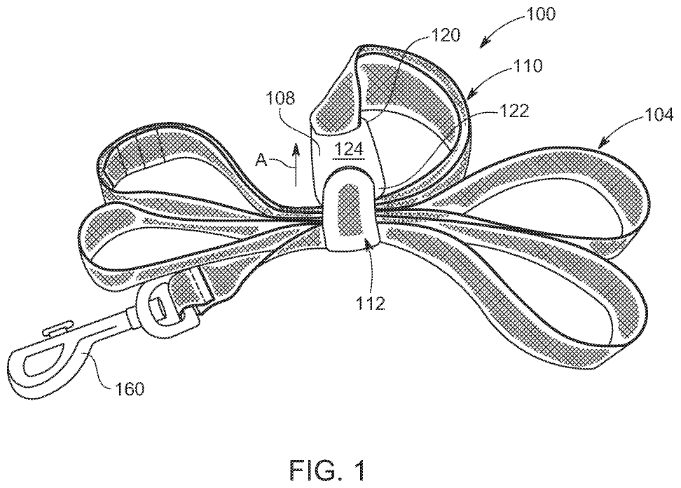

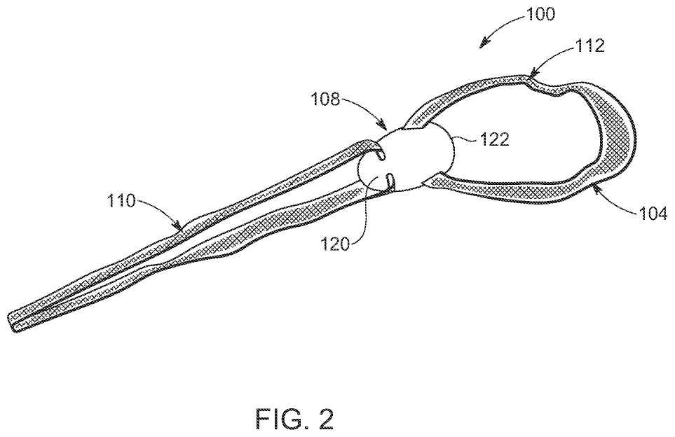

Referring to FIG. 1 and FIG. 2, a leash 100 to be worn by (or attached to) a pet like a cat, a dog, or any other pet is shown. The leash 100 includes a strap 104 and a gripping body 108 (hereinafter referred to as body 108) engaged with the strap 104 and adapted to move along a length of the strap 104. The strap 104 is formed of a flexible, or nonrigid, material and includes a continuous loop. The body 108 is engaged with the strap 104, which defines a first loop portion 110 and a second loop portion 112, the second loop portion 112 being separated from the first loop portion 110 by the body 108. The length or size of the first loop portion 110 and the second loop portion 112 are varied by sliding the body 108 along the strap 104.

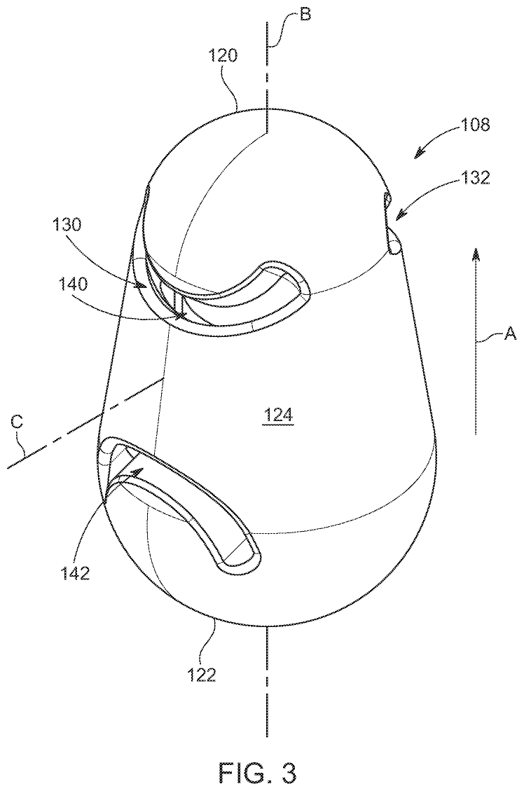

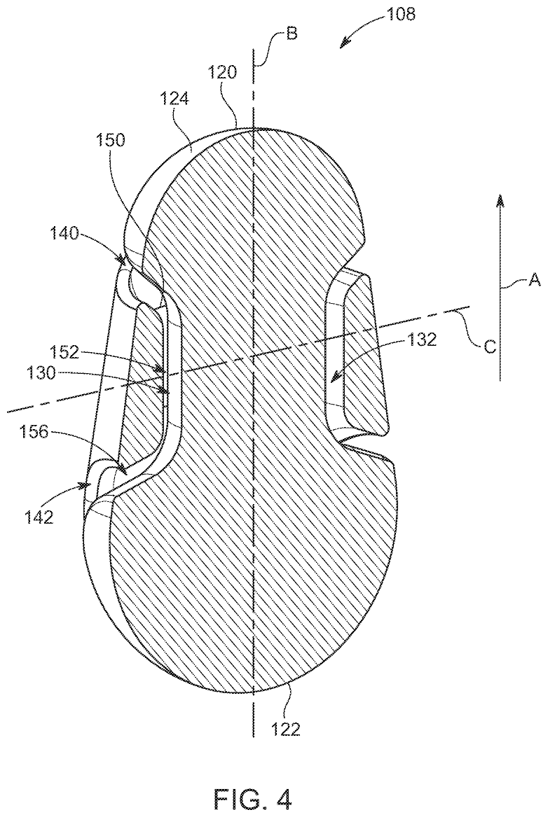

Referring to FIGS. 3 and 4, the body 108 preferably includes an ovoidal shape having a first longitudinal end 120, a second longitudinal end 122 arranged opposite to the first longitudinal end 120, and an outer surface 124. As shown, the width of the body 108 proximate to the first longitudinal end 120 is narrower than the width of the body 108 proximate the second longitudinal end 122. The width of the body 108 decreases in a longitudinal direction ‘A’ from the second longitudinal end 122 to the first longitudinal end 120. Although the body 108 having an ovoidal shape is shown and contemplated, it may be envisioned that the body 108 can include any other suitable shape, such as, but not limited to, a spherical shape, a teardrop shape, an elliptical shape, or any other such suitable shape that permits the body 108 to be gripped by the hand of a user.

Further, the body 108 defines at least two passageways, for example, a first passageway 130 and a second passageway 132, extending through the body 108 generally in the longitudinal direction “A.” As shown, the first passageway 130 and the second passageway 132 are arranged spaced apart and opposite to each other and may be arranged substantially parallel to each other. As shown, the first passageway 130 and the second passageway 132 are symmetrically positioned on both sides of a central longitudinal axis “B.” Preferably, the body 108 is symmetrical about the longitudinal axis “B.” In an embodiment, the body 108 consists of two axes of symmetry, one axis being the central longitudinal axis “B” and the other being an axis substantially perpendicular to the longitudinal axis “B.” The first passageway 130 and the second passageway 132 are preferably identical in structure. For the sake of clarity and brevity, the structure of only the first passageway 130 is explained in detail below.

The first passageway 130 includes a first opening 140 defined at the outer surface 124 and arranged proximate to the first longitudinal end 120, and a second opening 142 defined at the outer surface 124 and arranged proximate to the second longitudinal end 122. Both the openings 140, 142 are arranged on the same side of the longitudinal axis “B.” As shown in FIG. 4, the first passageway 130 includes a first portion 150 extending obliquely toward the second longitudinal end 122 and the longitudinal axis “B” inside the body 108 from the first opening 140. The first passageway 130 also includes a second portion 152 extending from the first portion 150 towards the second longitudinal end 122 in a substantially longitudinal direction “A” and parallel to the longitudinal axis “B.” The first passageway 130 further includes a third portion 156 extending from the second portion 152 to the second opening 142. The third portion 156 extends obliquely and outwardly from the second portion 152 to the second opening 132. Preferably, the first portion 150 and the third portion 156 are symmetrically arranged on two sides of a lateral axis “C” of the body 108. In an embodiment, and as shown in FIG. 3, the first opening 140 and the second opening 142 are in the form of slits and preferably have arcuate/curved shapes.

The strap 104 extends through the first passageway 130 and the second passageway 132, and defines the second loop portion 112 formed by a continuous length of the strap 104 that extends between the passageways 130, 132. Accordingly, the body 108 separates the loop into two loop portions 110, 112. To attach the strap 104 to the body 108, an end of the strap 104 is inserted through the first passageway 130 and then through the second passageway 132 and is attached to another end of the strap 104. Importantly, the strap 104 passes freely through the first passageway 130 and the second passageway 132 to easily adjust the length and size of the second loop portion 112. Furthermore, the slitted, arcuate, or curved shapes of the first opening 140 and the second opening 142 provide some level of resistance to the strap 104 passing through the first passageway 130 and the second passageway 132. The level of resistance can be further increased by the pet owner by gripping the body 108 and the portions of the strap 104 extending out of the first and second openings 140, 142. In addition, the curved shapes of the first opening 140 and the second opening 142 also help impart that same curvature to the strap 104, which in turn helps the strap 104 maintain an open loop that is easy for the pet owner to grasp.

In an embodiment, the ends of the strap 104 are sewn together (or otherwise secured together) to form a single lead. Moreover, the leash 100 may include a connector 160 (shown in FIG. 1) engaged with the strap 104. The connector 160 provides an engagement of the leash 100 with a pet collar or harness.

Furthermore, the two loop portions 110, 112 along with the body 108 facilitate in holding the pet with a hand of the user in a variety of ways. For example, the connector 160 is secured to a pet's collar or harness, and the second loop portion 112 is secured around a wrist of the user with the body 108 held in the palm of the user. Alternatively, the user can grip the body 108 with one hand, while grabbing the second loop portion 112 with a second hand. Yet another use would be to slide the body 108 to the end of the second loop portion 112, thereby effectively eliminating any loop of the strap 104 in the second loop portion 112. As a result, the user can then simply grab the body 108. Furthermore, the two loop portions 110, 112 and the body 108 allow the pet to be secured to a pole (not shown). This is accomplished by securing the second loop portion 112 around the pole with the strap 104 secured to the pet, and the position of the body 108 along the strap 104 is adjusted to tightly engage/secure the second loop portion 112 around the pole.

The leash 100 serves to provide a proper grip by the pet owner. The body 108 of the leash 100 easily fits into the hands of the pet owner and is easily engaged with a carabiner (not shown) or any ring being held by the pet owner either on a waist or hands of the pet owner. When used with a carabiner, the strap 104 extends through the carabiner and the body 108 is positioned on the opposite side of the carabiner from the pet, such that the carabiner restrains the strap 104. Although the pet owner does not need to actively hold the body 108 or strap 104 while in use, advantageously the pet owner can quickly and easily shorten the length of the strap 104 extending beyond the carabiner (in order to pull the pet closer to the pet owner) by simply pulling on the body 108.

Additionally, the body 108 of the leash 100 is easily captured and gripped by the pet owner while wearing gloves. Furthermore, tightly adjusting the length of the second loop portion 112 around the hands of the pet owner provides a strong grip, particularly when the pet owner is wearing bulky gloves. In addition, the strap 104 can be easily tied and secured to a bicycle or any static pillar for constraining any motion of the pet.

It should be understood that the foregoing description is only illustrative of the aspects of the disclosed embodiments. Various alternatives and modifications can be devised by those skilled in the art without departing from the aspects of the disclosed embodiments. Accordingly, the aspects of the disclosed embodiments are intended to embrace all such alternatives, modifications, and variances that fall within the scope of the appended claims. Furthermore, the mere fact that different features are recited in mutually different dependent or independent claims does not indicate that a combination of these features cannot be advantageously used, such as a combination remaining within the scope of the aspects of the disclosed embodiments.

What is claimed is:

1. A leash comprising:
a strap of flexible material forming a loop; and
a body including at least two passageways extending through the body;
wherein the strap extends through each of the passageways, and the loop of the strap is formed by a continuous length of the strap that extends between the passageways.

2. The leash of claim 1, wherein the body is spherical.

3. The leash of claim 1 wherein the body is ovoidal.

4. The leash of claim 3, wherein the ovoidal body consists of two axes of symmetry.

5. The leash of claim 3, wherein the ovoidal body consists of one axis of symmetry.

6. The leash of claim 1, wherein the body has at least one pair of openings, and each of the passageways extends between a respective pair of the openings.

7. The leash of claim 6, wherein at least one of the openings is a slit.

8. The leash of claim 7, wherein the slit is curved.

9. The leash of claim 8, wherein both of the openings in the pair of openings are a slit.

10. The leash of claim 9, wherein both of the openings in the pair of openings are a curved slit.

11. The leash of claim 1, wherein the body consists of two passageways extending through the body.

12. The leash of claim 6, wherein the body has two pairs of openings, and each of the passageways extends between a respective pair of the openings.

13. The leash of claim 1, wherein the passageways are symmetrical with one another about an axis extending along the body.

14. The leash of claim 1 wherein the strap is configured to slide through the passageways in order to selectively vary the size of the loop.

15. The leash of claim 3 wherein the strap is configured to slide through the passageways in order to selectively vary the size of the loop.

16. The leash of claim 6 wherein the strap is configured to slide through the passageways in order to selectively vary the size of the loop.
